(19) United States
(12) Patent Application Publication
(10) Pub. No.: US 2002/0114677 A1
(43) Pub. Date: Aug. 22, 2002

(54) DRILL BLADE WITH SLOT FOR REMOVING CUT MATERIALS

(76) Inventor: Kiichiro Ishikawa, Marietta, GA (US)

Correspondence Address: Terry W. Kramer, Kramer & Associates, Suite 1101, 2001 Jeff. Davis Hwy., Arlington, VA, 22202, US

(21) Appl. No.: 09/788,440

(22) Filed: Feb. 21, 2001

(51) Int. Cl. B23B 51/04

(52) U.S. Cl. 408/205; 408/207

(57) ABSTRACT

A drill bit has an annular cutting edge to form a hole in a workpiece. The drill bit is received within a drill and rotated above 20,000 revolutions per minute. A distal end of the drill bit defines an annular edge surrounding a hollow cavity. The annular edge both cuts and melts the workpiece during formation of the hole. The drill bit also defines an exit hole passing perpendicular to an axial center of the drill bit. The exit hole and the hollow cavity join within an interior of the drill bit to form a material passage way. Core material cut from the workpiece is collected within the hollow area of the drill bit during operation. Rotational forces of the drill bit eject the core material thus allowing the drill bit to cut multiple holes without manually removing core material from the hollow cavity.

### BACKGROUND OF THE INVENTION

1. Field of the Invention

The present invention relates to the field of drill bits. More particularly, the present invention relates to the field of hollow drill bits for cutting circular holes in a workpiece.

2. Description of the Prior Art

In the art of cutting circular holes in a workpiece, several types of drill bits are used. Drill bits for drilling a hole in wood, metal and plastic traditionally cut a circular hole by grinding or cutting the entire portion of the material. The drill bit traditionally has a chevron tip to form the hole and a plurality of helical grooves extending from the tip along a cylindrical outer periphery. The bit produces a hole by separating small particles from the material, which are then brushed or blown away. However, in the art of hollow drill bits, a circular hole is cut in a workpiece by an annular cutting surface of the bit itself while leaving core material within a hollow portion of the bit. The core material is then removed from the drill bit in preparation for the next cut. Traditional hollow drill bits fail to have any workable mechanism for removing this core material. Furthermore, if the type of workpiece is a cloth or webbing material, the drill bit cuts a ragged hole in the material leaving the edges frayed with a number of threads unraveled.

### SUMMARY OF THE INVENTION

It is therefore an object of the present invention to provide a hollow drill bit that removes core material from a hollow portion in the tip of the drill bit during operation.

It is a further object of the present invention to provide a hollow drill bit for cutting holes in fabric or webbing material while reducing the amount of fraying of the material.

It is a further object of the present invention to provide a drill bit that can perform a drilling operation while melting a portion of cloth or webbing material to leave a hole that does not fray or rip.

Objects of the invention are achieved by a cylindrical drill bit to form a hole in a workpiece. The drill bit includes a proximate end to be received within a drill. A distal end of the drill bit defines an annular cutting edge surrounding an outer perimeter of a hollow cavity. The drill bit also includes an exit section contiguous with the proximate end and the distal end. The exit section defines an exit hole passing perpendicular to an axial center of the drill bit. The exit hole and the hollow cavity join within an interior of the drill bit to form a material passage way.

Further objects of the invention are achieved by a cylindrical drill bit to form a hole in a workpiece. A proximate end of the drill bit is received within a drill and rotated at a speed above 20,000 revolutions per minute. A distal end of the drill bit defines an annular cutting edge surrounding an outer perimeter of a hollow cavity. The annular cutting edge both cuts and melts workpiece during formation of the hole. An exit section of the drill bit is contiguous with both the proximate end and the distal end of the drill bit. The exit section defines an exit hole passing perpendicular to an axial center of the drill bit. The exit hole and the hollow cavity join within an interior of the drill bit to form a material passage way.

The foregoing is illustrative of the objects and features of the present invention and is not intended to be exhaustive or limiting of the possible advantages that can be realized or achieved. These and other objects and advantages of the present invention will be readily apparent to those skilled in the art from the following description.

### BRIEF DESCRIPTION OF THE DRAWINGS

FIG. 1 is a side view of a hollow drill bit defining an exit hole according to an embodiment of the present invention.

FIG. 2 is a side view of the hollow drill bit of FIG. 1 rotated 90 degrees about a longitudinal axis thereof.

FIG. 3 is an end view of a drill bit according to an embodiment of the present invention.

FIG. 4 is an elevated perspective view of a drill bit according to an embodiment of the present invention.

FIG. 5 is an environmental view of a drill bit cutting through a workpiece.

### DETAILED DESCRIPTION OF THE INVENTION

Referring now to the drawings and in particular FIG. 1, wherein like numerals refer to like components, hollow drill bit 10 is shown and described. Drill bit 10 defines a cylindrical shaft and is formed from a plurality of contiguous sections, namely proximate end 11, exit section 13, and distal end 12. Proximate end 11 is so configured and arranged to be removably inserted into a drill. Exit section 13 is contiguous with proximate end 11 and distal end 12, and defines an exit hole 14. Hollow cavity 16 is defined within proximate end 11 and joins exit hole 14 within drill bit 10. The joinder of hollow cavity 16 and exit hole 14 defines a transition area 17. Distal end 12 forms an annular cutting edge 15, which operates to remove material during rotation of drill bit 10. Annular cutting edge 15 itself defines an entrance to hollow cavity 16 within distal end 12. Together, hollow cavity 16 and exit hole 14 form a material passage way for the removal of material cut by annular cutting edge 15.

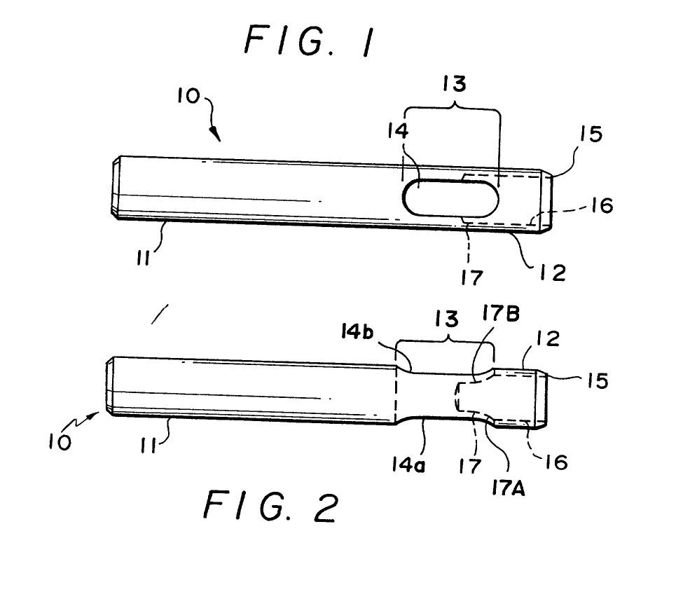

FIG. 2 is a side view of the hollow drill bit of FIG. 1 rotated 90 degrees about a longitudinal axis thereof. As illustrated in FIG. 2, exit hole 14 defines a pair of exit passages, namely exit passage 14a and exit passage 14b. Each of the exit passages 14a and 14b connect with hollow cavity 16 to thereby define separate pathways for the egress of cut material from hollow cavity 16. Of course, because drill bit 10 has a generally cylindrical outer periphery, exit passages 14a and 14b appear scalloped in the side view of FIG. 2.

According to an embodiment of the present invention, exit hole 14 is oblong in the longitudinal direction of drill bit 10 to form an oblong slot passing through an axial center of drill bit 10. According to a more particular embodiment of the present invention, exit hole 14 is obround and is formed by routing a passage directly through the side of drill bit 10 and passing through the axis.

As particularly illustrated in FIG. 2, hollow cavity 16 meets with exit passage 14a about transition seam 17a and with exit passage 14b about transition seam 17b. According to an embodiment of the present invention, hollow cavity 16 is formed by drilling a hole along the axial center of drill bit 10. Transition area 17 is therefore the juncture of edge of material remaining from the formation of exit hole 14 and hollow cavity 16. According to an embodiment of the present invention (not shown), hollow cavity 16 extends the entire length of exit section 13, such that the transition area 17 is virtually eliminated. According to the illustrated embodiment of the present invention, hollow cavity 16 extends between ¼ and ½ of the way into exit section 13 to particularly define transition area 17.

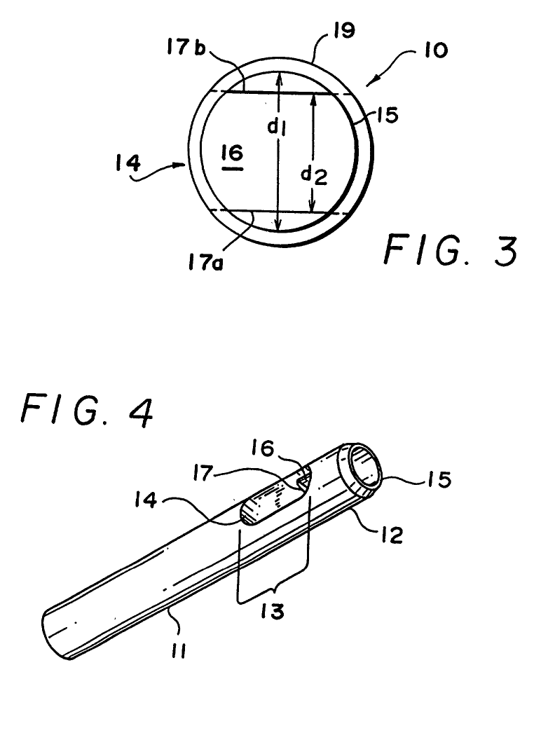

FIG. 3 is an end view of drill bit 10 according to an embodiment of the present invention. As particularly illustrated, annular cutting edge 15 is defined as the edge of hollow cavity 16 and outer bevel 19. FIG. 3 particularly illustrates that the width d1 of hollow cavity 16 is greater than the width d2 of exit hole 14. Transition seam 17a and transition seam 17b, which together form transition area 17, are particularly illustrated in FIG. 3. The transition area 17 is the location where hollow cavity 16 meets exit hole 14. According an embodiment of the present invention (not shown), transition area 17 is formed at a proximate end of exit hole 14 with width d1 of hollow cavity 16 being larger than width d2 of exit hole 16. In this case, transition area 17 changes abruptly between d1 and d2. According to the illustrated embodiment, hollow cavity 16 extends into exit hole 14 between ¼ and ½ of the length of exit hole 14, with d1 greater than d2. In this case, transition area 17 still changes abruptly between d1 and d2. However, transition area 17 changes within the exit section 13 and may frictionally direct removal of material out of exit hole 14. In yet another alternative embodiment (not shown), hollow cavity 16 extends into a portion of exit hole 14 with a tapered, i.e. smooth transition between d1 and d2. Nevertheless, according to the above embodiments of the present invention, the cut material bends or turns during ejection from exit hole 14, which may cause loosening of some types of threaded material during passage there through.

FIG. 4 is an elevated perspective view of drill bit 10 according to an embodiment of the present invention. As illustrated, drill bit 10 has proximate end 11 in connection with the exit section 13, which is further connected to the distal end 12. Transition area 17 is easily viewed from FIG. 4. As shown, hollow cavity 16 extends into exit hole 14. Transition area 17 is defined as the junction of the perimeter of hollow cavity 16 and the perimeter of exit hole 14, and may be of at least three configurations. First, the perimeter of hollow cavity 16 can meet with the perimeter of exit hole 14 at a distal end of exit hole 14 with an abrupt change in size. Alternatively, the perimeter of hollow cavity extends past the distal end of exit section 14, with an abrupt change between width d1 hollow cavity and width d2 of exit hole 14. This forces cut material to either bend or turn during exit from exit hole 14. In yet another alternate configuration, the perimeter of hollow cavity 16 extends into the perimeter of exit hole 14 with a tapered transition.

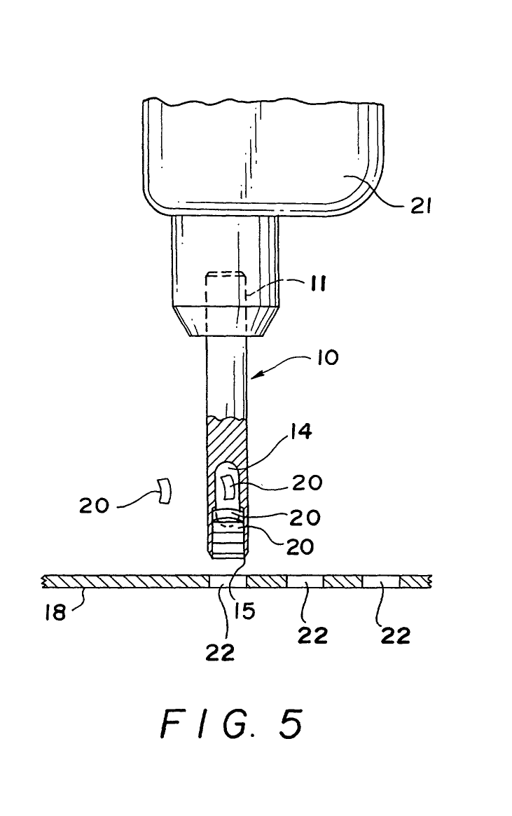

FIG. 5 is an environmental view of drill bit 10 operating to form a hole within workpiece 18. As illustrated, the proximate end 11 of drill bit 10 is mounted within drill 21. During operation, drill bit 10 rotates much faster than a conventional wood or masonry drill bit. According to an embodiment of the present invention, drill bit 10 rotates faster than 20,000 rpms. According to a more preferred embodiment of the present invention, drill bit 10 rotates between 35,000 and 45,000 rpms. According to a preferred embodiment of the present invention, drill bit 10 rotates at an approximate rate of 40,000 rpms.

At the preferred rate of 40,000 rpms, annular cutting blade 15 of drill bit 10 contacts workpiece 18 while performing both a cutting operation and a melting operation. The dual action of both cutting and melting is important for forming holes in man-made fabrics such as nylon, polycarbonate acrylic, polyethylene, polyurethane and PVC fabric materials. The cutting action is useful for such materials as leather. According to the embodied speeds of rotation, friction between the cutting blade 15 and workpiece 18 causes extreme heat, which acts to perform the melting operation. The melting operation provides a clean cut. Further, man-made materials, such as nylon or other low melting point materials are cut and melted such that no fraying of the cut area takes place. As particularly illustrated in FIG. 5, as drill bit 10 cuts holes 22, material 20 is stacked into hollow cavity 16 of drill bit 10. The stacked material 20 is eventually raised to the level of exit hole 14 during the formation of the holes 22. As material 20 reaches the level of exit hole 14, the material 20 is ejected from exit hole 14. The operation then repeats to form a plurality of additional holes in workpiece 18.

Although the present invention has been described in detail with particular reference to preferred embodiments thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the following claims.

What is claimed:

1. A cylindrical drill bit to form a hole in a workpiece, comprising:
a proximate end so configured and arranged to be received within a drill;
a distal end defining an annular cutting edge surrounding an outer perimeter of a hollow cavity; and
an exit section contiguous with said proximate end and said distal end, the exit section defining an exit hole passing perpendicular to an axial center of the drill bit, wherein the exit hole and the hollow cavity join within an interior of the drill bit to form a material passage way.

2. The drill bit of claim 1, wherein the exit hole is oblong and passes entirely through the axial center of the drill bit.

3. The drill bit of claim 2, wherein the exit hole is obround.

4. The drill bit of claim 2, wherein the exit hole is oblong in the axial direction of the drill bit and has an associated width perpendicular to the axial direction, and the hollow cavity has an associated diameter being larger that the width of the exit hole.

5. The drill bit of claim 2, wherein the material passage way includes at least one transition seam defined by an intersection of a wall of the exit hole and a wall of the hollow cavity.

6. The drill bit of claim 1, wherein the drill rotates the drill bit at a speed above 20,000 revolutions per minute.

7. The drill bit of claim 6, wherein the drill rotates the drill bit at a speed between 35,000 and 45,000 revolutions per minute.

8. The drill bit of claim 7, wherein the drill rotates the drill bit at a speed of approximately 40,000 revolutions per minute.

9. The drill bit of claim 1, wherein the exit hole has an associated width and the hollow cavity has an associated diameter, such that a transition area is defined as a location where the exit hole meets the hollow cavity.

10. The drill bit of claim 1, wherein the hollow cavity has an associated depth within the drill bit, and the depth of the hollow cavity meets a distal end of the exit hole to thereby form the material passage way.

11. The drill bit of claim 1, wherein the hollow cavity has an associated depth within the drill bit, and the depth of the hollow cavity extends between a distal end of the exit hole and a proximate end of the exit hole to thereby form the material passage way.

12. The drill bit of claim 1, wherein the hollow cavity has an associated depth within the drill bit, and the depth of the hollow cavity meets a proximate end of the exit hole to thereby form the material passage way.

13. The drill bit of claim 1, wherein the drill rotates the drill bit at a speed to both cut and melt the workpiece when in contact with the annular cutting edge.

14. A drill bit to form a hole in a material, comprising:
a distal end defining an annular edge surrounding an outer perimeter of a hollow cavity; and
an exit section contiguous with said distal end, the exit section defining an exit hole passing entirely through the drill bit, wherein the exit hole and the hollow cavity join to form at least two material passage ways for egress of a portion of the material during formation of the hole.

15. The drill bit of claim 14, wherein the drill bit is symmetrical with respect to a plane passing through the longitudinal axis of the drill bit.

16. The drill bit of claim 14, wherein the exit hole has an associated width perpendicular to an axial direction of the drill bit, and the hollow cavity has an associated diameter being larger that the width of the exit hole.

17. The drill bit of claim 14, wherein the drill rotates the drill bit at a speed to both cut and melt the material when in contact with the annular edge.

18. The drill bit of claim 17, wherein the speed of rotation of the drill bit is between 20,000 and 60,000 revolutions per minute.

19. The drill bit of claim 14, wherein the hollow cavity has an associated depth within the drill bit, and the depth of the hollow cavity extends between a distal end of the exit hole and a proximate end of the exit hole to thereby form the material passage way.

20. A cylindrical drill bit to form a hole in a workpiece, comprising:
a proximate end to be received within a drill and rotated at a speed between 20,000 and 60,000 revolutions per minute;
a distal end defining an annular cutting edge surrounding an outer perimeter of a hollow cavity, the annular cutting edge both cutting and melting the workpiece during formation of the hole; and
an exit section contiguous with said proximate end and said distal end, the exit section defining an exit hole passing perpendicular to an axial center of the drill bit, the exit hole and the hollow cavity joining within an interior of the drill bit to form a material passage way,
wherein the exit hole is oblong in the axial direction of the drill bit and has an associated width perpendicular to the axial direction, and the hollow cavity has an associated diameter being larger that the width of the exit hole.
